(19) United States
(12) Patent Application Publication
(10) Pub. No.: US 2025/0335796 A1
(43) Pub. Date: Oct. 30, 2025

(54) MACHINE LEARNING MODELS OPERATING AT DIFFERENT FREQUENCIES FOR AUTONOMOUS VEHICLES

(71) Applicant: Tesla, Inc., Austin, TX (US)

(72) Inventor: Anting Shen, Mountain View, CA (US)

(21) Appl. No.: 19/259,524

(22) Filed: Jul. 3, 2025

Related U.S. Application Data
(63) Continuation of application No. 18/482,332, filed on Oct. 6, 2023, now Pat. No. 12,367,405.
Application No. 18/482,332 is a continuation of application No. 16/701,669, filed on Dec. 3, 2019, now Pat. No. 11,816,585.
(60) Provisional application No. 62/774,793, filed on Dec. 3, 2018.

(51) Int. Cl. G06N 5/04; G06N 20/00

(52) U.S. Cl. CPC G06N 5/04; G06N 20/00

(57) ABSTRACT

Systems and methods include machine learning models operating at different frequencies. An example method includes obtaining images at a threshold frequency from one or more image sensors positioned about a vehicle. Location information associated with objects classified in the images is determined based on the images. The images are analyzed via a first machine learning model at the threshold frequency. For a subset of the images, the first machine learning model uses output information from a second machine learning model, the second machine learning model being performed at less than the threshold frequency.

### CROSS-REFERENCE TO RELATED APPLICATIONS

Any and all applications for which a foreign or domestic priority claim is identified in the Application Data Sheet as filed with the present application are hereby incorporated by reference under 37 CFR 1.57.

### BACKGROUND

### Field of the Disclosure

This application relates generally to the machine vision field, and more specifically to enhanced object detection from a vehicle.

### Description of the Related Art

In the field of machine vision for autonomous vehicles, automotive image sensors (e.g., cameras) are typically capable of high frame rates of 30 frames per second (fps) or more. However, deep learning based image processing algorithms may be unable to keep up with the high camera frame rates without significantly reducing accuracy, range, or both. Such algorithms may be run at 20 fps or less. This may result in a waste of the additional camera information available, which may thus be unused in image processing and object detection tasks.

Typically, slower machine learning models (e.g., object detectors) which run at slower frame rates than the cameras' frame rates, may have high accuracy, but long latencies, meaning that it can take longer for these slower machine learning models to produce an output. The output may therefore become stale by the time it's outputted. For example, a slower machine learning model detecting an image may take 200 milliseconds to do so. In the 200 milliseconds it takes for the machine learning model to output the detected image, the image has likely moved. To resolve this, a faster machine learning model may be employed. However, the faster machine learning model may be less accurate. As may be appreciated, less accuracy may result in a higher likelihood of false negatives and false positives. For automotive applications, for example, a false negative may represent vehicles in an image that the machine learning model fails to detect, while a false positive may represent a machine learning model predicting a vehicle in a location of the image when there is no vehicle present.

### BRIEF DESCRIPTION OF THE DRAWINGS

FIG. 1 is a schematic representation of an example object detection system according to one embodiment.

FIG. 2 is a flowchart of an example process for object detection according to one embodiment.

FIG. 3 is a block diagram illustrating an example of object detection using a detector and a tracker according to one embodiment.

FIG. 4 is a block diagram illustrating an example of object detection using a first detector and a second detector according to one embodiment.

### DETAILED DESCRIPTION

Although some embodiments described throughout generally relate to systems and methods for object detection, it will be appreciated by those skilled in the art that the systems and methods described can be implemented and/or adapted for a variety of purposes within the machine vision field, including but not limited to: semantic segmentation, depth estimation, three-dimensional bounding box detection, object re-identification, pose estimation, action classification, simulation environment generation, and sensor fusion.

Embodiments relate to techniques for autonomous driving or navigation by a vehicle. As described herein, one or more image sensors (e.g., cameras) may be positioned about a vehicle. For example, there may be 4, 6, 9, and so on, image sensors positioned at different locations on the vehicle. The image sensors may obtain images at one or more threshold frequencies, such as 30 frames per second, 60 frames per second, and so on. The obtained images may depict a real-world setting in which the vehicle is located. As an example, the real-world setting may include other vehicles, pedestrians, road hazards and the like located proximate to the vehicle. The vehicle may therefore leverage the captured images to ensure that the vehicle is safely driven. For example, the vehicle may generate alerts for viewing by a driver. In this example, an alert may indicate that a pedestrian is crossing a cross-walk. As another example, the vehicle may use the images to inform autonomous, or semi-autonomous, driving and/or navigation of the vehicle.

As described in more detail below, in some embodiments two or more machine learning models may be used to analyze images, or other sensor information, obtained from image sensors positioned about a vehicle. The machine learning models may be implemented via a system of one or more processors, application-specific integrated circuits (ASICs), and so on. In some embodiments, analyzing an image may include performing a forward pass of a deep learning network. The analysis may include classifying an object in an image and determining location information for the object. Location information may, as an example, indicate a bounding box within the image that depicts the object. Location information may also indicate pixels of the image which form the object.

A first machine learning model may analyze images at a first frequency. For example, the first machine learning model may be a “faster” model capable of analyzing all images obtained at the full image sensor frame rate (e.g., 30 frames per second, 60 frames per second, and so on). A second machine learning model may analyze images at a second, lower, frequency. For example, the second machine learning model may be a comparatively slower machine learning model capable of analyzing a subset of the obtained images (e.g., every 2^{nd} image, every 5^{th} image, and so on). Advantageously, the first machine learning model may periodically receive information from the second machine learning model to enhance an accuracy associated with analyzing images.

In some embodiments, the first machine learning model and the second machine learning model may be detectors. A detector, as an example, may be used to detect an object (e.g., classify an object, determine location information, and so on). With respect to the above, the first machine learning model may detect objects with an associated accuracy less than the second machine learning model. For example, the second machine learning model may be more computationally expensive (e.g., the model may have more convolutional networks, layers, and so on).

As will be described, in these embodiments the second machine learning model may therefore analyze the subset of images to accurately detect objects in the subset of images. The first machine learning model may analyze all, or a substantial portion, of the images from the image sensors. Periodically, the first machine learning model may receive output information from the second machine learning model. This output information may be provided as an input, along with an image being analyzed, to the first machine learning model. The second machine learning model may provide supplemental information to the first machine learning model. In this way, an accuracy associated with detection of objects by the first machine learning model may be increased.

In some embodiments, the first machine learning model may be a tracker while the second machine learning model may be a detector. A tracker, as an example, may be used to track (e.g., estimate) a location of an object between images. For example, a tracker may track location information associated with a pedestrian. As will be described, the second machine learning model may be used to detect objects. The first machine learning model may estimate movement of the detected objects in images while the second machine learning model is processing a subsequent image. In some embodiments, the first machine learning mode may use additional sensor input, such as inertial measurement unit (IMG) information, global navigation satellite system (GNSS) information, and so on, to track locations of an object.

While machine learning models are described, such as deep learning models, it may be appreciated that classifiers, detectors, trackers, support vector machines, and so on, may be used and fall within the scope of the disclosure. Additionally, in some embodiments an output of the slower machine learning model may include detected objects. For example, classifications of the objects, location information, and so on, may be provided to the faster machine learning model. In some embodiments, an output of the slower machine learning model may represent feature maps, or other outputs associated with a convolutional network. This output may be provided to the faster machine learning model, which may be trained to periodically use such feature maps when detecting and/or tracking objects.

### Overview

In one embodiment the method for object detection includes: receiving a first frame from a camera; processing the first frame with a first image processing engine receiving a second frame from the camera while the first frame is being processed; sending the processed output of the first frame to a second image processing engine with a faster processing speed that the first image processing engine; and combining the processed output of the first frame with the second frame to generate an object detection result for the first frame.

The method functions to provide an image processing system that combines multiple image processing engines to provide object detection outputs at a frame rate and accuracy much higher than either single image processing engine would achieve.

In one variation, combining the processed output of the first frame with the second frame is performed in order to allow the faster image processing engine to use the information from the slower image processing engine in order to make the information more accurate than it would have been with the faster image processing engine's output alone.

In one example, the method processes a high proportion of the images from a video stream output by a camera (e.g., all images, 90% of the images, etc.) with a fast, low accuracy detector. The slow detector generates a low-accuracy output for the detected objects (e.g., position, orientation, optical flow, motion vectors, other object features, etc.), preferably in substantially real-time (e.g., faster than the camera framerate), for subsequent use by a navigation system or other low-latency endpoint. The method concurrently processes a subset of the images from the same video stream with a slow, high accuracy detector, wherein the outputs of the slow detector (which lag behind the fast detector and the camera) are used as priors or input features for the fast detector. In one example, the fast detector can store the object features extracted from each image frame (or differences between image frames) that were sampled after a first image (that is being processed by the slow detector). Once the slow detector output is received by the fast detector, the fast detector can re-calculate the object features based on the more accurate object features output by the slow detector and the object parameter deltas to generate a higher-accuracy output (e.g., the fast detector's output is periodically recalibrated based on the slow detector's output). In a specific example, combining the low-accuracy outputs and the high-accuracy output can involve using the slower image processing engine's output combined with optical flow and motion vectors from the first image, moving the boxes by how much the car has moved in the second image, and then adjusting to generate the image prediction result for the second frame.

All or portions of the method can be performed at a predetermined frequency, performed upon occurrence of an execution event (e.g., upon an autonomous vehicle engaging in driving), or performed at any suitable time.

### System

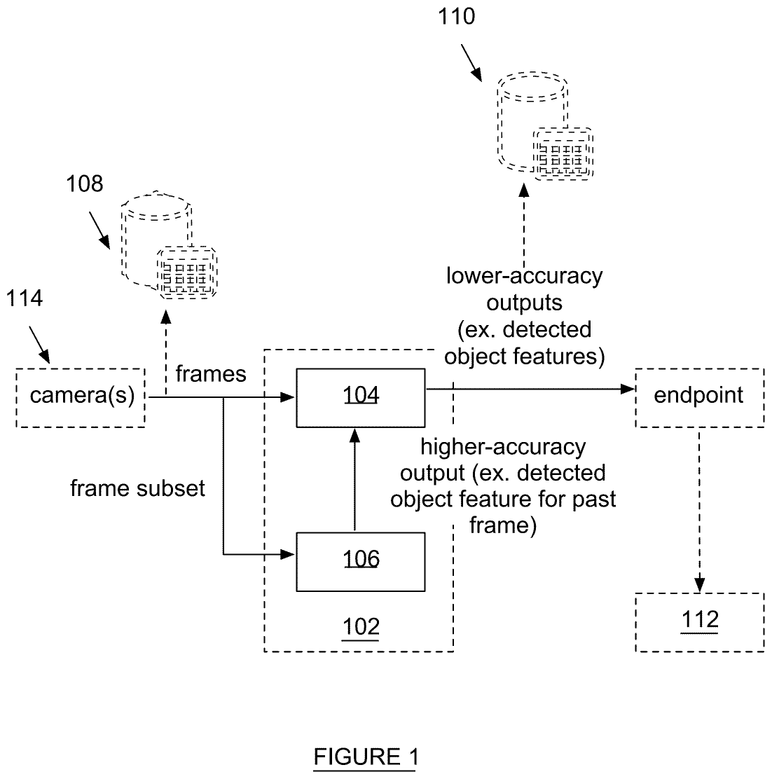

As shown in FIG. 1, one embodiment of an image processing system 100 can include: an image processing network 102, a first image processing engine 104, a second image processing engine 106, an image database 108, an output database 110, a client device or devices 112, and a camera or cameras 114. In some embodiments, processing the images includes one or more of image classification, object recognition, object detection, and object tracking.

In variants, the image processing network 102 functions to facilitate communication between various components of the system (e.g., between the image processing engines, between the image processing engines and the endpoint, etc.), but can additionally or alternatively perform any other suitable functionality. The image processing network can additionally or alternatively host or execute the other components of the system (e.g., the image processing engines). The image processing network can be: a scheduler, a set of processing systems (e.g., processors, ASICs, etc.), or be otherwise configured.

The first image processing engine 104 and second image processing engine 106 communicate with the image processing network 102 to process received images. In some embodiments, the first image processing engine 104 and second image processing engine 106 are components of the same computer device as the image processing network 102, while in other embodiments the first image processing engine 104, second image processing engine 106, and image processing network 102 are all components of separate computer devices. Any combination of components and computer devices may be contemplated.

In some embodiments, the image processing engines 104 and 106 may be deep learning image processing engines, non-deep learning image processing engines, or a combination of deep learning and non-deep learning image processing engines. In some embodiments, the image processing engines 104 and 106 may be detectors of varying image processing speeds, while in other embodiments the image processing engines 104 and 106 are a combination of a detector and a tracker, respectively. In some embodiments, the image processing engines 104 and 106 receives images in the form of a series of video frames from a camera. In some embodiments, the camera is an automotive camera placed within an autonomous vehicle for machine vision purposes, such as detecting objects on the road during the car's operation and predicting locations of objects in future frames based on the locations of the objects in current and past frames.

In some embodiments, the first image processing engine is capable of relatively “slow” image processing speeds, such as 20 fps or lower. In some embodiments, a slow detector may provide high accuracy and provide infrequent high accuracy output. In some embodiments, the first image processing engine is a detector selected from a predefined list of available detectors. In some embodiments, the detector may be chosen or selected with or without human input, according to such criteria as latency and accuracy requirements for a given image processing task.

In one variation, the first image processing engine is a high-accuracy or high-precision (e.g., higher than 50% mAP, 70% mAP, 80% mAP; etc.), high-latency (e.g., slower than 20 fps, slower than 30 fps, etc.) image processing engine. The first image processing engine is preferably an object detector (e.g., region-based convolutional network (R-CNN), fast R-CNN, region-based fully convolutional network (R-FCN), a detector using selective search, exhaustive search, deep learning, etc.), but can alternatively or additionally be: an object recognition algorithm, an object classifier, or any other suitable image processing engine. The second image processing engine can be a low-accuracy or low precision (e.g., lower than 60% mAP, 50% mAP, 40%, mAP; etc.), low-latency (e.g., faster than 30 fps, faster than 10 fps, etc.) image processing engine. The second image processing engine can be an object detector, classifier, or recognition algorithm (e.g., you only look once (YOLO), fast YOLO, YOLOv2, etc.), an object tracker (e.g., optical flow, point tracking, kernel tracking, silhouette tracking, etc.), or be any other suitable processor.

In one variation, the system includes a combination of two deep learning based detectors, one capable of outputting image prediction results at a relatively faster frame rate per second (fps) than the other. In another variation, the system includes a combination of a deep learning based detector (e.g., the slow detector) and a non-deep learning based tracker (e.g., the slow detector). A tracker follows one or multiple objects of interest within a scene or set of images to continuously provide their position. A tracker may estimate parameters of the dynamic system, including feature point positions and object position, using video from one or more cameras as the source of information. Detectors find objects of interest and provide their positions within an image. There is no assumption of system dynamics, nor is the response based on temporal consistency. Detectors use a single image, such as a single frame from a camera, as the source of information.

In some embodiments, the first and second image processing engines can perform tasks related to semantic segmentation. For example, the methods herein can be performed using semantic segmentation to calculate drivable area. In some embodiments, the first and second image processing engines perform tasks related to three-dimensional objects. For example, detecting boxes in three dimensions, segmentation in three dimensions, and predicting the three-dimensional orientation of objects can be performed using the methods herein.

Frame database 108 stores the frames from the camera into a database as they are outputted from the camera and sent to the image processing system 100. Output database 110 stores the output from the first image processing engine 104 and second image processing engine 106 based on the received images. In some embodiments, the output includes image prediction results, e.g., predictions of the future locations of objects in the images.

Client device(s) 112 are devices that send information to the image processing network 102, receive information from the image processing network 102, or both. A client device may include, e.g., one or more components of an autonomous vehicle, or a computer device associated with one or more users, organizations, or other entities.

Camera(s) 114 are devices that record visual information in video and/or image form and generate outputs of them in “frames” that represent a series of images in sequence for a given moment in time. In some embodiments, the camera(s) are positioned on one or more autonomous vehicles, and output frames while the vehicle is in operation. In some embodiments, the camera(s) are configured to output frames at a speed of 30 fps or higher.

The system can optionally include one or more chipsets or processing hardware that functions to execute all or a portion of the method. The processing hardware is preferably collocated with the processing hardware executing the endpoint application (e.g., executing the navigation method), but can additionally or alternatively be located on-board the component using the system outputs (e.g., on-board a vehicle or a robot), located remote from the component, or be otherwise arranged. The processing hardware can include one or more: embedded systems, microcontrollers, microprocessors, ASICs, CPUs, GPUs, TPUs, or any other suitable processing system.

In some embodiments, all or part of the processing hardware is located in an autonomous vehicle or across multiple autonomous vehicles, or in a central system or cloud associated with an autonomous vehicle fleet or network. In some embodiments, all of part of the processing within the system is performed in parallel across multiple processing components. In some embodiments, all or part of the processing within the system is performed in series across multiple processing components. In some embodiments, all or part of the processing tasks, camera output frames or image data are cached or available locally or offline for processing. In some embodiments, the system is partly or fully located within a cloud network.

In variants where the processing hardware's computation resources are limited (e.g., microcontrollers, ASICS, etc.), the system can automatically cluster layers of the first and/or second image processing engines into blocks (e.g., in variants wherein the first and/or second image processing engines include neural networks), such that the image processing engines can be interrupted when more urgent functions need to be executed. For example, the layers of the first image processing engine or slow detector (e.g., a DNN) can be clustered into blocks that are: intermittently run when the second image processing engine or fast detector is not consuming the computing resources; or constantly run but interrupted (e.g., at a break between sequential blocks) when a new video frame needs to be processed by the second image processing engine or fast detector. The blocks are preferably even, but can alternatively be uneven. However, limited computing resources can be otherwise managed. In variants where the processing hardware has multiple cores or can support multiple threads, the first image processing engine and second image processing engine can be executed in parallel (e.g., on different cores or threads). However, the computing resources can be otherwise allocated to different image processing processes of the method.

### Example Methods/Block Diagrams

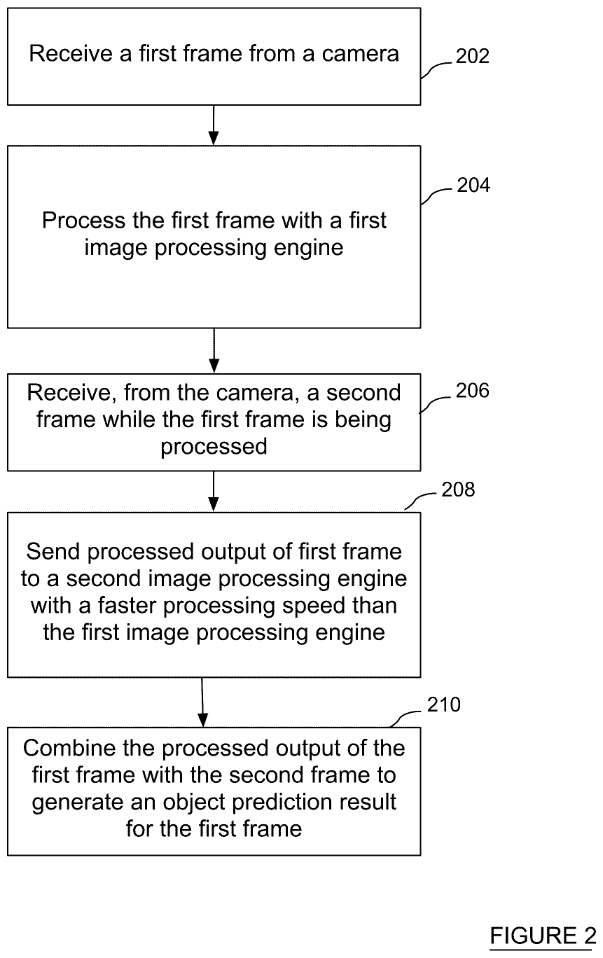

FIG. 2 is a flowchart representation of one embodiment of a method for detecting objects.

At step 202, system 100 receives a first frame from a camera. In some embodiments, the camera records video and outputs a first frame from the video, then sends it to system 100. In some embodiments, the camera takes a series of still images, and outputs a first frame representing a still image, then sends it to system 100. In some embodiments, system 100 stores the first frame in frame database 108.

At step 204, system 100 processes the first frame with a first image processing engine. In some embodiments, the first image processing engine is a detector capable of detecting objects within an image. In some embodiments, the first image processing engine is a tracker capable of tracking the locations of detected objects. In some embodiments, processing the first frame involves one or more of image classification, object detection, and object tracking. In some embodiments, the first image processing engine is a ‘slow’ detector, e.g., capable of generating image processing outputs at a speed of 20 fps or less. Slow detectors are typically highly accurate and provide infrequent high accuracy output. Slow detectors may be, for example, high compute, high resolution networks, or high compute, low resolution networks.

At step 206, system 100 receives a second frame from the camera while the first frame is being processed. In some embodiments, system 100 receives the second frame before the processing in step 204 is completed. In some embodiments, the second frame is the next frame in a series or sequence of frames the camera outputs in a video or other feed related to a sequence. The second frame is preferably processed by the second image processing engine (e.g., as discussed above, alternatively by any other suitable image processing engine) in real- or near-real time (e.g., substantially immediately, in 10% of the camera frame rate, etc.), but can be otherwise processed. In some embodiments, system 100 receives multiple frames in between the first frame and the second frame. The multiple frames can be used for image prediction, object detection, tracking, or other purposes within the image processing system 100.

At step 208, system 100 sends processed output of the first frame to a second image processing engine. In some embodiments, the second image processing engine has a faster processing speed than the first image processing engine. In some embodiments, the second image processing engine has a slower processing speed than the first image processing engine. In some embodiments, the first image processing engine may be a detector while the second is a tracker. In some embodiments, both the first and second image processing engines are detectors, with one capable of faster image processing speeds than the other. In some embodiments, the first image processing engine and the second image processing engine share the computational load within a single device or network of devices. In some embodiments, the first image processing engine is a deep learning based processor, while the second image processing engine is a non-deep learning based processor. In other embodiments, both processors are deep learning based processors. In some embodiments, the second image processing engine is a low compute, high resolution network. In some embodiments, the second image processing engine is a low compute, low resolution network. In some embodiments, the second image processing engine is a detector chosen from a predefined list of available detectors. In some embodiments, the detector may be chosen in such a way that the frame rate of the detector's output is equal to the camera's frame rate. In some embodiments, the frame rate of the detector's output is slightly faster than the camera's frame rate, with or without sharing the computational load of the first image processing engine. In some embodiments, the processed output includes results of the image processing of the first frame, such as detection of one or more images in the first frame, tracking of the locations of one or more images in the first frame, predicting the future locations of one or more images in the first frame, or other image processing results.

In some embodiments, the slow image processing engine does not receive every frame that is generated as output from the camera and sent to the system 100. In one variation, the slow image processing engine receives a frame from the camera (for processing) only when its processing and computational resources are not being expended on processing another frame. For example, if frame 1 is sent from the camera to the system 100 and the slow image processing engine has available resources that are not being used for processing a frame, then system 100 directs frame 1 to be sent to the slow image processing engine to be processed. When frame 2 is sent from the camera to the system 100 and the slow image processing engine is still using those resources to process frame 2, and insufficient resources remain to process frame 2, then system 100 does not direct frame 2 to be sent from the camera to the slow image processing engine. In a second variation, the slow image processing engine receives every Nth frame, wherein N can be selected based on: the camera sampling rate and the slow image processing engine's image processing rate (e.g., wherein sampling N frames can take longer than the time it takes for the slow processing engine to process a single frame), be predetermined, be determined based on the fast image processing engine's accuracy (e.g., wherein N can be smaller when the fast image processing engine is less accurate; larger when the fast image processing engine is more accurate; etc.), or be otherwise determined.

At step 210, system 100 combines the processed output of the first frame with the second frame to generate an object prediction result for the first frame. In some embodiments in which the first and second image processing engines are a detector and a tracker, system 100 combines the processed output of the first frame with the second frame by a method involving optical flow. Due to the tracker, the locations of objects from the first frame are known, and the image constituting the second frame has been received. In order to predict the locations of objects in the second frame, system 100 computes the optical flow between the two images of the first frame and second frame to obtain the motion vectors at each pixel. The motion vectors at each pixel provide information on how much each pixel has moved from the first frame to the second frame. System 100 averages the information on how much each pixel has moved to calculate how much the locations of objects have moved from the first frame to the second frame. System 100 then takes the boxes or boundaries of the objects in the first frame, and moves them by a certain amount to obtain a prediction of object locations in a future frame, such as a third or fourth frame. However, the processed output of the first frame and the second frame can be otherwise combined.

In some embodiments in which the first and second image processing engines are a slower detector and a faster detector, the faster detector can never predict new objects, it can only adjust the locations obtained by the slower detector for existing objects' locations. System 100 outputs the first frame's object's location after the second frame's object's location. This increases the accuracy compared to using only the output of the slower detector or the faster detector. No new objects will be detected until the slower detector has processed the frame and detected them. The faster detector will then make the locations of the objects more accurate, and can update the locations of the objects every frame. In this way, at every frame, the faster detector updates the locations of objects, and at every other frame, the slower detector looks for objects to detect. This leads to a more refined detection of the locations than methods including either using a fast detector that's comparatively less accurate on every frame, or using a slow detector with good detection of objects every other frame.

In some embodiments, the outputs of the first image processing engine, second image processing engine, or both are cached. If the image processing network 102 cannot run two neural networks at the same time, for example, then execution of the first image processing engine will have to be paused by system 100 while the second image processing engine runs. After the second image processing engine is finished running, system 100 will have to re-execute. In other embodiments, rather than caching the outputs of the image processing engines, system 100 executes the first and second image processing engine serially, or executes the first and second image processing engine in parallel.

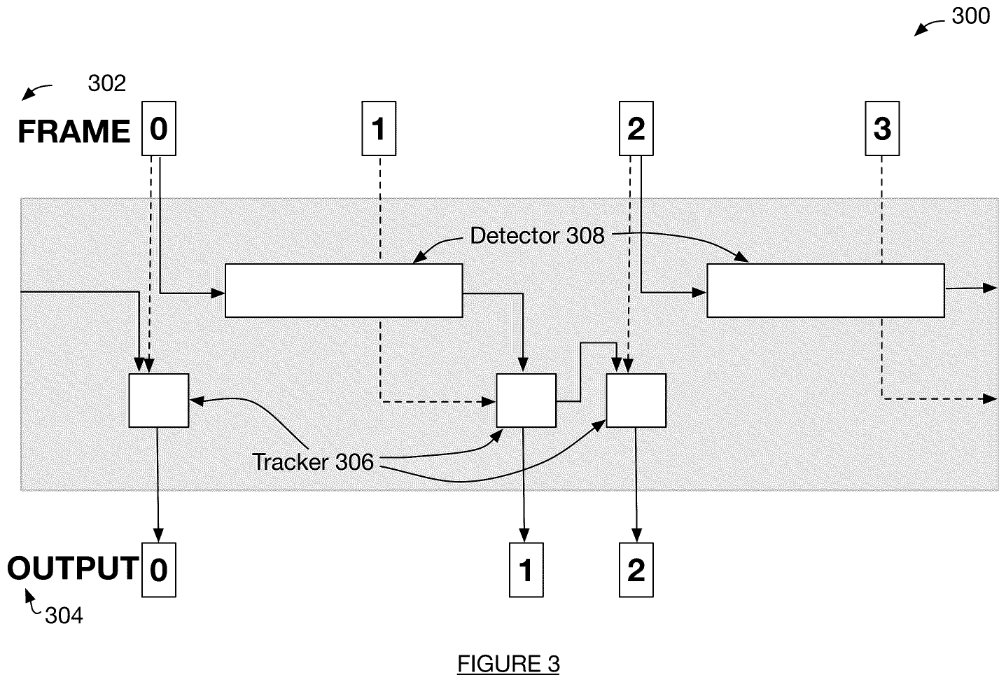

FIG. 3 is an illustration of an example 300 of object detection using a detector and a tracker. Example 300 reads from left to right with frame 302 being outputted from a camera and received by system 100. Frame o, or the first frame, is received by system 100, and system 100 sends it to tracker 306. Tracker 306 in example 300 has a latency of 5 ms, which represents the latency time for the tracker 306 to produce an output after receiving a frame from the camera. System 100 also sends frame o to detector 308, which has a latency of 50 ms. Thus, detector 308 produces an output 50 ms after receiving a frame from the camera. The camera in example 300 produces output frames at 33 ms.

Tracker 306 receives frame o from the camera as an input, and, in some embodiments, receives an additional input constituting an output from detector 308. Tracker 306 processes the image of frame o by determining the object locations of identified objects within frame o, and produces an output 304 constituting output o for frame o.

Detector 308 receives frame o from the camera, and begins processing the image of frame o to identify objects within the frame as well as their locations. Detector 308 is slower than tracker 306, and thus the processing time takes longer. While detector 308 is processing frame o, frame 1, or the second frame, is received by system 100 from the camera. System 100 sends frame 1 to tracker 306.

Once detector 308 finishes processing frame o, detector 308 sends the output to system 100. System 100 sends the output of detector 308 processing frame o to tracker 306. At this point, tracker 306 has received the inputs of frame 1 from the camera and the output of frame o from the detector 308. Tracker 306 then takes in the identified objects and locations from frame o as determined by detector 308, and the image of frame 1 from the camera, and combines both of them into an output for frame 1. In some embodiments, the tracker 306 calculates the optical flow between the two images of frame o and frame 1 to get the motion vectors at each pixel. The motion vectors provide information of how much each pixel has moved. Tracker 306 averages the motion vectors for a particular object to determine how much that object has moved from frame o to frame 1 to generate bounding boxes. Tracker 306 then takes the bounding boxes from frame o and moves them by a set amount to predict image locations for frame 1. Tracker 306 then sends the output of that prediction as output 1.

In a similar fashion to the prior steps, frame 2 is received by system 100, which sends frame 2 to both tracker 306 and detector 308 as inputs. Tracker 306 receives frame 2 as an input, as well as the prediction result of frame 1 determined earlier. Tracker 306 then processes frame 2 and determines locations of identified objects within frame 2, then outputs that as output 2.

Detector 308 receives frame 2 as input, and begins processing frame 2 to identify objects and their locations within frame 2. While detector 308 is processing, frame 3 is received by system 100. System 100 sends frame 3 to tracker 306. When detector 308 is finished processing frame 2, the output is sent to tracker 306, which receives it as input. This processes continues for additional frames until the image processing task completes, the camera stops outputting frames and sending them to system 100, or some other triggering event occurs to stop the process.

The result of example 300 is that system 100 with tracker 306 and detector 308 produces outputs at 30 fps and 5-20 ms of latency, which is to be compared to 15 fps and 50 ms latency when a naive method of only the detector is used. Thus, superior speed is achieved, which allows for potentially better accuracy when compared to techniques such as shrinking a neural network down to the same speed.

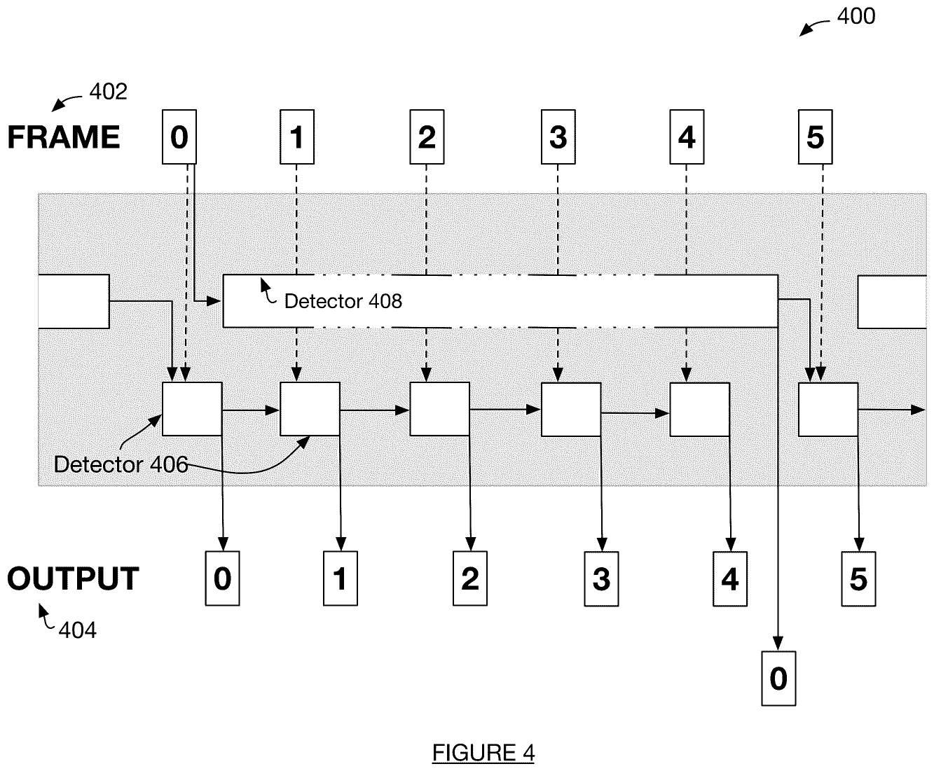

FIG. 4 is an illustration of an example 400 of object detection using a first detector and a second detector. Detector 408 in example 400 produces outputs at 80 ms latency, and is paired with faster detector 406, which produces outputs at 15 ms latency. The camera produces output frames at 33 ms. In some embodiments, both detector 406 and detector 408 are deep learning neural networks. In some embodiments, detector 408 employs a high compute, low resolution neural network, while detector 406 employs a low compute, low resolution neural network. In some embodiments, the faster detector 406 has the ability to use information from the previous frame.

Frames 402 are produced as outputs by the camera. Frame o is received by system 100, which sends it to the faster detector 406. In some embodiments, detector 406 also receives an additional input from detector 408. Detector 406 performs image processing tasks to produce an output 404, in this case output o. Detector 406 reuses the information obtained from the previous frame o, and also receives frame 1 as input. Detector 408 also receives frame o and begins processing. Detector 406 receives additional frames 2, 3, and 4, processes them, and outputs them as outputs 2, 3, and 4. Meanwhile, slower detector 408 continues processing frame o.

Once detector 408 finishes processing frame o, it sends the output o, which is a high accuracy prediction of identified objects and their locations, to faster detector 406. System 100 sends frame 5 from the camera to faster detector 406 as additional input. Detector 406 uses the high accuracy prediction from five frames ago, as outputted by detector 408, and updates it with the more recent frame 5 to generate more accurate predictions of object locations. In this sense, detector 406 is trained on the high accuracy prediction every fifth frame and trained on the previous low accuracy prediction every frame other than the fifth frame. In some embodiments, detector 406 uses machine learning techniques to learn using this previous data, including high accuracy predictions when they are available, and lower accuracy predictions otherwise. This leads to different weights being assigned to the neural network based on the different level of accuracy. Weights are the parameters of the neural network that constitute the output of the change in accuracy. This process repeats until the image processing task is completed, the camera stops outputting frames to system 100, or some other triggering event occurs.

In some embodiments of examples 300 and 400, both examples use a slower image processing engine as a prior input to a faster image processing engine in order to get an output at the speed of the faster image processing engine, but with information from the slower image processing engine with the aim of boosting accuracy beyond what the faster image processing engine can achieve by itself.

### Other Embodiments

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the preferred embodiments of the description without departing from the scope of this invention defined in the following claims.

Each of the processes, methods, and algorithms described in the preceding sections may be embodied in, and fully or partially automated by, code modules executed by one or more computer systems or computer processors comprising computer hardware. The code modules (or “engines”) may be stored on any type of non-transitory computer-readable medium or computer storage device, such as hard drives, solid state memory, optical disc, and/or the like. The systems and modules may also be transmitted as generated data signals (for example, as part of a carrier wave or other analog or digital propagated signal) on a variety of computer-readable transmission mediums, including wireless-based and wired/cable-based mediums, and may take a variety of forms (for example, as part of a single or multiplexed analog signal, or as multiple discrete digital packets or frames). The processes and algorithms may be implemented partially or wholly in application-specific circuitry. The results of the disclosed processes and process steps may be stored, persistently or otherwise, in any type of non-transitory computer storage such as, for example, volatile or non-volatile storage.

In general, the terms “engine” and “module”, as used herein, refer to logic embodied in hardware or firmware, or to a collection of software instructions, possibly having entry and exit points, written in a programming language, such as, for example, Java, Lua, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on one or more computer readable media, such as a compact discs, digital video discs, flash drives, or any other tangible media. Such software code may be stored, partially or fully, on a memory device of the executing computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage. Electronic Data Sources can include databases, volatile/non-volatile memory, and any memory system or subsystem that maintains information.

The various features and processes described above may be used independently of one another, or may be combined in various ways. All possible combinations and subcombinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “for example,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y and Z,” unless specifically stated otherwise, is otherwise understood with the context as used in general to convey that an item, term, etc. may be either X, Y or Z. Thus, such conjunctive language is not generally intended to imply that certain embodiments require at least one of X, at least one of Y and at least one of Z to each be present.

The term “a” as used herein should be given an inclusive rather than exclusive interpretation. For example, unless specifically noted, the term “a” should not be understood to mean “exactly one” or “one and only one”; instead, the term “a” means “one or more” or “at least one,” whether used in the claims or elsewhere in the specification and regardless of uses of quantifiers such as “at least one,” “one or more,” or “a plurality” elsewhere in the claims or specification.

The term “comprising” as used herein should be given an inclusive rather than exclusive interpretation. For example, a general purpose computer comprising one or more processors should not be interpreted as excluding other computer components, and may possibly include such components as memory, input/output devices, and/or network interfaces, among others.

While certain example embodiments have been described, these embodiments have been presented by way of example only, and are not intended to limit the scope of the disclosure. Thus, nothing in the foregoing description is intended to imply that any particular element, feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

It should be emphasized that many variations and modifications may be made to the above-described embodiments, the elements of which are to be understood as being among other acceptable examples. All such modifications and variations are intended to be included herein within the scope of this disclosure. The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated.

1. (canceled)

2. A system comprising:
one or more cameras;
one or more processors coupled to the one or more cameras, the one or more processors configured to:
implement a first trained machine learned model configured to:
receive first image data from the one or more cameras; and
based on the first image data and at a first time, detect new object data not previously detected by the system; and
implement a second trained machine learned model configured to:
receive second image data from the one or more cameras and prior object data previously detected by the first trained machine learned model; and
based on the second image data and the prior object data previously detected and at a time prior to the first time, determine a location for the prior object data.

3. The system of claim 2, wherein the second model is not trained to output new objects.

4. The system of claim 2, wherein the second image data includes the first image data.

5. The system of claim 2, wherein a portion of the second image data is not included in the first image data.

6. The system of claim 2, wherein the first model and the second model operate at different sampling rates.

7. The system of claim 2, wherein the second model is a tracker or a detector.

8. The system of claim 2, wherein the second model is further configured to determine a location based on received inertial measurement unit information or global satellite system information.

9. A method implemented by a system of one or more processors, the method comprising:
receiving first image data from a one or more cameras;
detecting, by a first trained machine learned model, new object data not previously detected by the system, based on the first image data at a first time;
receiving second image data from the one or more cameras;
receiving prior object data previously detected by the first trained machine learned model; and
determining at a time prior to the first time, by a second machine learned model, a location for the prior object data based on the second image data and the prior object data.

10. The method of claim 9, wherein the second model is not trained to output new objects.

11. The method of claim 9, wherein the second image data includes the first image data.

12. The method of claim 9, wherein a portion of the second image data is not included in the first image data.

13. The method of claim 9, wherein the first model and the second model operate at different sampling rates.

14. The method of claim 9, wherein the second model is a tracker or a detector.

15. The method of claim 9, wherein the second model is further configured to determine a location based on received inertial measurement unit information or global satellite system information.

16. Non-transitory computer storage media storing instructions that when executed by a system of one or more processors, cause the one or more processors to perform operations comprising:
receiving first image data from a one or more cameras;
detecting, by a first trained machine learned model, new object data not previously detected by the system, based on the first image data at a first time;
receiving second image data from the one or more cameras;
receiving prior object data previously detected by the first trained machine learned model; and
determining at a time prior to the first time, by a second machine learned model, a location for the prior object data based on the second image data and the prior object data.

17. The computer-storage media of claim 16, wherein the second model is not trained to output new objects.

18. The computer-storage media of claim 16, wherein the second image data includes the first image data.

19. The computer-storage media of claim 16, wherein a portion of the second image data is not included in the first image data.

20. The computer-storage media of claim 16, wherein the first model and the second model operate at different sampling rates.

21. The computer-storage media of claim 16, wherein the second model is a tracker or a detector.
